(19) United States
(12) Patent Application Publication
(10) Pub. No.: US 2004/0205017 A1
(43) Pub. Date: Oct. 14, 2004

(54) System and method for performing duty exemption and duty drawback for products purchased through bidding online

(76) Inventors: Sun-Chang Lin, Tu-chen (TW); Jun Cai, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/828,137

(22) Filed: Apr. 19, 2004

(30) Foreign Application Priority Data
Apr. 14, 2003 (TW) 92109034

(51) Int. Cl. G06F 17/60

(52) U.S. Cl. 705/37

(57) ABSTRACT

A system for performing duty exemption and duty drawback for products purchased through bidding online includes a website (12), an application server (13), a database (15), a plurality of client computers (10) and supplier computers (17), and a customs computer (19). The application server includes a basic data maintenance module (130), an online bidding procurement module (131), a duty exemption and duty drawback management module (132) and an account reconcilement module (133). The online bidding procurement module is provided for performing price enquiry, quoting and price negotiation, and for managing online bidding activities. The duty exemption and duty drawback management module is provided for generating duty exemption documents, duty drawback documents and customs declarations, and for completing duty exemption and duty drawback. A related method for performing duty exemption and duty drawback for products purchased through bidding online is also disclosed.

### BACKGROUND OF THE INVENTION

1. Field of the Invention

The present invention relates to procurement management systems and methods, and especially to a system and method which can perform duty exemption and duty drawback for products purchased through bidding online.

2. Background of the Invention

Procurement is one of the most important functions in corporate management, particularly management of a manufacturing corporation. Procurement efficiency directly affects the viability and development of a corporation. Products that can be purchased include not only tangible objects such as raw materials, machines and office equipment, but also include intangible things such as technologies and services. In the current era of economic globalization, more and more corporations are seeking efficient procurement management in order to reduce operating costs, improve the quality of products and develop new technologies.

Traditionally, most procurement procedures are handled manually. Manual operations are time-consuming and costly in comparison with modern automated processes. With the development of computer science and network technology, online procurement methods based on the Internet are becoming more and more popular with corporations, due to their low costs, simple processes, and ability to provide end-to-end services. Online procurement methods can electronically manage the whole array of procurement procedures, which fully utilizes the value-added characteristics of electronic management.

The art of performing online procurement utilizing computers and networks is disclosed in patents such as U.S. Pat. No. 5,970,474 issued on Oct. 19, 1999, and entitled Electronic Procurement System and Method for Trading Partners. This patent discloses an electronic business system comprising three hardware configurations: a corporation server, a supplier sever and an electronic trade management system. The electronic business system allows users of a purchasing organization to access the corporation server through an intranet to transmit information on products to be purchased, and access the supplier server through the Internet to trade online with the corresponding supplier. However, the patent only describes a system of trading between a purchasing organization and a supplier through a connection of an information system, and does not disclose means of purchasing products through bidding online.

China Patent No. 1,373,436A issued on Oct. 9, 2002 and entitled Method and System for Performing Online Procurement by Computer provides a supplier trade system, for a purchasing organization and a plurality of suppliers to perform online procurement operations. The supplier trade system comprises a quotation management system, a product trade management system, a price enquiry management system, and an order search management system. However, the supplier trade system does not predetermine a plurality of suitable suppliers. All suppliers that provide the product to be purchased can participate in online bidding activities, which results in complicated procurement processes and procurement inefficiency.

Moreover, the two systems do not deal with tax issues that arise in relation to procurement procedures. When the purchased product is a duty-free product or a duty drawback product, duty exemption and customs entry are involved. In these circumstances, efficient cooperation between a purchasing organization, relevant suppliers and the customs authority is needed in order to simplify procurement processes and improve procurement efficiency. Accordingly, what is needed is a system and method for performing operations of duty exemption and duty drawback for products purchased through bidding online.

### SUMMARY OF THE INVENTION

A main objective of the present invention is to provide a system and method for performing duty exemption and duty drawback for products purchased through bidding online, in which not only can products be purchased by online bidding activities, but also duty exemption and duty drawback can be carried out according to types of the products.

To accomplish the above objective, a system for performing duty exemption and duty drawback for products purchased through bidding online in accordance with a preferred embodiment of the present invention comprises a website, an application server, a database, a plurality of client computers and supplier computers, and a customs computer. The application server comprises: a basic data maintenance module for maintaining data used or generated in online bidding activities and in procedures of duty exemption and duty drawback; an online bidding procurement module for performing price enquiry, quoting and price negotiation, and for managing online bidding activities; a duty exemption and duty drawback management module for generating duty exemption documents, duty drawback documents and customs declarations, and completing duty exemption and duty drawback for products purchased through bidding online; and an account reconcilement module for reconciling relevant accounts after the purchased products are checked and accepted

The present invention also provides a method for performing duty exemption for a product purchased through bidding online. The method comprises the steps of: (1) receiving procurement data; (2) selecting a plurality of suitable suppliers according to the procurement data; (3) determining a winning supplier by online bidding activities, and entering a procurement contract with the winning supplier; (4) performing duty exemption operations if the purchased product is a duty-free product; and (5) checking the product delivered by the winning supplier, and reconciling corresponding accounts.

Further, the present invention provides a method for performing duty drawback for a product purchased through bidding online. The method comprises the steps of: (1) receiving procurement data; (2) selecting a plurality of suitable suppliers according to the procurement data; (3) determining a winning supplier by online bidding activities, and entering a procurement contract with the winning supplier; (4) performing duty drawback operations if the purchased product is a duty drawback product; and (5) checking the product delivered by the winning supplier, and reconciling corresponding accounts.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is a schematic diagram of hardware configuration of a system for performing duty exemption and duty drawback for products purchased through bidding online in accordance with the preferred embodiment of the present invention;

FIG. 2 is a schematic diagram of main software function modules of an application server of the system of FIG. 1;

FIG. 3a is a schematic diagram of main function sub-modules of a basic data maintenance module of the application server;

FIG. 3b is a schematic diagram of main function sub-modules of an online bidding procurement module of the application server;

FIG. 4 is a flowchart of a preferred method for performing duty exemption and duty drawback for a product purchased through bidding online according to the present invention; and

FIG. 5 is a flowchart of a preferred method for determining a winning supplier through bidding online.

### DETAILED DESCRIPTION OF THE INVENTION

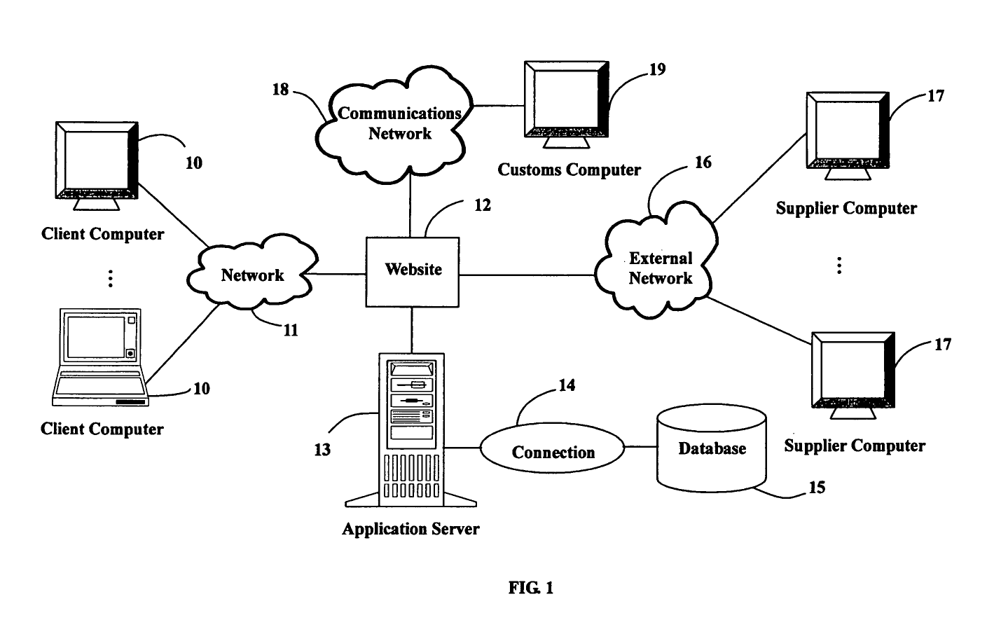

FIG. 1 is a schematic diagram of hardware configuration of a system for performing duty exemption and duty drawback for products purchased through bidding online in accordance with the preferred embodiment of the present invention. The system comprises a plurality of client computers 10, a website 12, an application server 13, a database 15, a plurality of supplier computers 17, and a customs computer 19. Each client computer 10 provides an interactive user interface for users of a purchasing organization to log on the website 12 to manage online bidding activities. The website 12 is connected to the application server 13, and provides an operating platform for purchasing products through bidding online. The website 12 may be a corporation's own website, or a third-party e-trading website. The application server 13 comprises a plurality of software function modules for maintaining information used or generated in the system, managing online bidding activities, performing duty exemption and duty drawback, and reconciling relevant accounts after accepting purchased products. The database 15 stores various information used or generated in the system. The information may include procurement data, supplier data, price-related records, bid-related records, duty exemption documents and duty drawback documents. Each supplier computer 17 provides an interactive user interface for users of a corresponding supplier to perform online bidding operations. The customs computer 19 facilitates operators of a customs authority (hereinafter, “customs”) to complete customs entries.

The client computers 10 are connected to the website 12 through a network 11. The network 11 may be an intranet, the Internet or any other suitable type of communications link. The application server 13 is connected to the database 15 through a connection 14, which is database connectivity such as Open Database Connectivity (ODBC) or Java Database Connectivity (JDBC). The website 12 may communicate with the supplier computers 17 through an external network 16, which may for example be the Internet. Further, the website 12 and the customs computer 19 communicate with each other via a communications network 18. The communications network 18 can be any appropriate communications architecture known in the art, such as an EDI communications network.

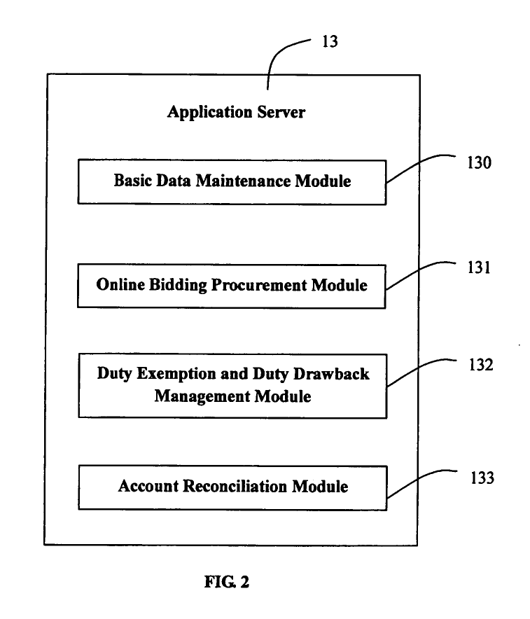

FIG. 2 is a schematic diagram of main software function modules of the application server 13. The application server 13 comprises a basic data maintenance module 130, an online bidding procurement module 131, a duty exemption and duty drawback management module 132, and an account reconcilement module 133.

The basic data maintenance module 130 maintains data used or generated in online bidding activities, duty exemption documents and duty drawback documents. The online bidding procurement module 131 performs operations of price enquiry, quoting and price negotiation, and manages online bidding activities. The duty exemption and duty drawback management module 132 is provided for generating duty exemption documents, duty drawback documents and customs declarations, and for completing operations of duty exemption and duty drawback for products purchased through bidding online. The account reconcilement module 133 is used for balancing relevant accounts after the purchased products are checked and accepted.

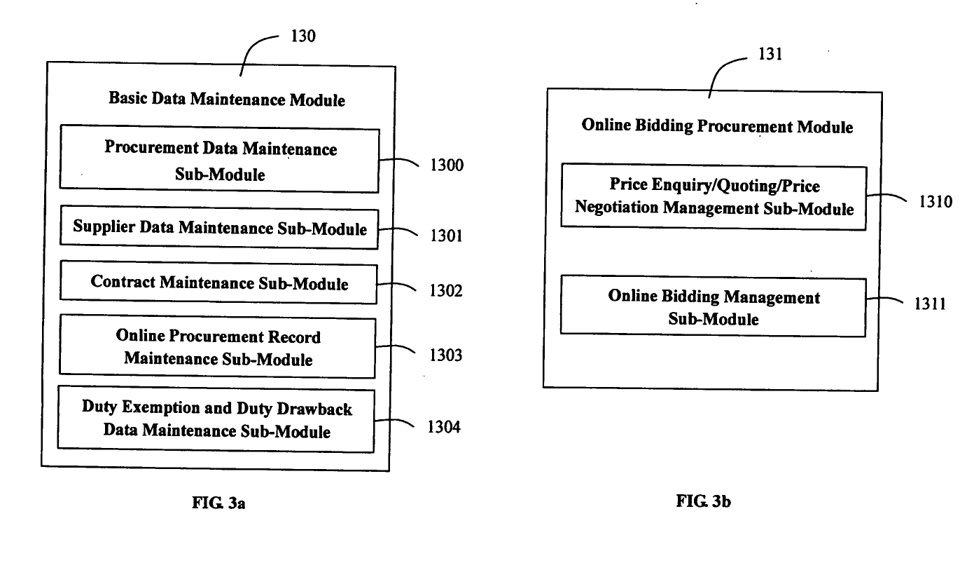

FIG. 3a is a schematic diagram of main function sub-modules of the basic data maintenance module 130 of the application server 13. The basic data maintenance module 130 comprises a procurement data maintenance sub-module 1300, a supplier data maintenance sub-module 1301, a contract maintenance sub-module 1302, an online procurement record maintenance sub-module 1303, and a duty exemption and duty drawback data maintenance sub-module 1304.

The procurement data maintenance sub-module 1300 is provided for maintaining procurement data, including information on products to be purchased. The information on products to be purchased may include names, types, quantities, quality requirements and delivery dates of the products. The purchased products include imported duty-free products and homemade duty drawback products. The supplier data maintenance sub-module 1301 is provided for maintaining basic information on suppliers and their products, and selecting a plurality of suitable suppliers according to the procurement data. Basic information on suppliers may include names, telephone numbers and addresses of the suppliers. Basic information on products of a supplier includes names, specifications, prices of the products, etc. The contract maintenance sub-module 1302 is provided for maintaining procurement contracts signed between the purchasing organization and winning suppliers. The online procurement record maintenance sub-module 1303 is provided for maintaining various records used or generated in processes of online bidding procurement. The records may include price-related records such as price inquiry records, quoting records and price negotiation records, and bid-related records such as bid opening records, bid comparing records and bid granting records. The duty exemption and duty drawback data maintenance sub-module 1304 is provided for maintaining information and documents used or generated in processes of duty exemption and duty drawback. The information and documents may include customs declarations, import duty-free proofs, duty drawback bills, etc.

FIG. 3b is a schematic diagram of main function sub-modules of the online bidding procurement module 131 of the application server 13. The online bidding procurement module 131 comprises a price enquiry/quoting/price negotiation management sub-module 1310, and an online bidding management sub-module 1311. The price enquiry/quoting/price negotiation management sub-module 1310 is provided for inquiring of prices, receiving quotations from selected suppliers, negotiating prices, and generating price-related records. The online bidding management sub-module 1311 is provided for opening a bid, comparing bidding results according to price-related records, determining a winning supplier and granting a winning bid to the winning supplier, and generating bid-related records.

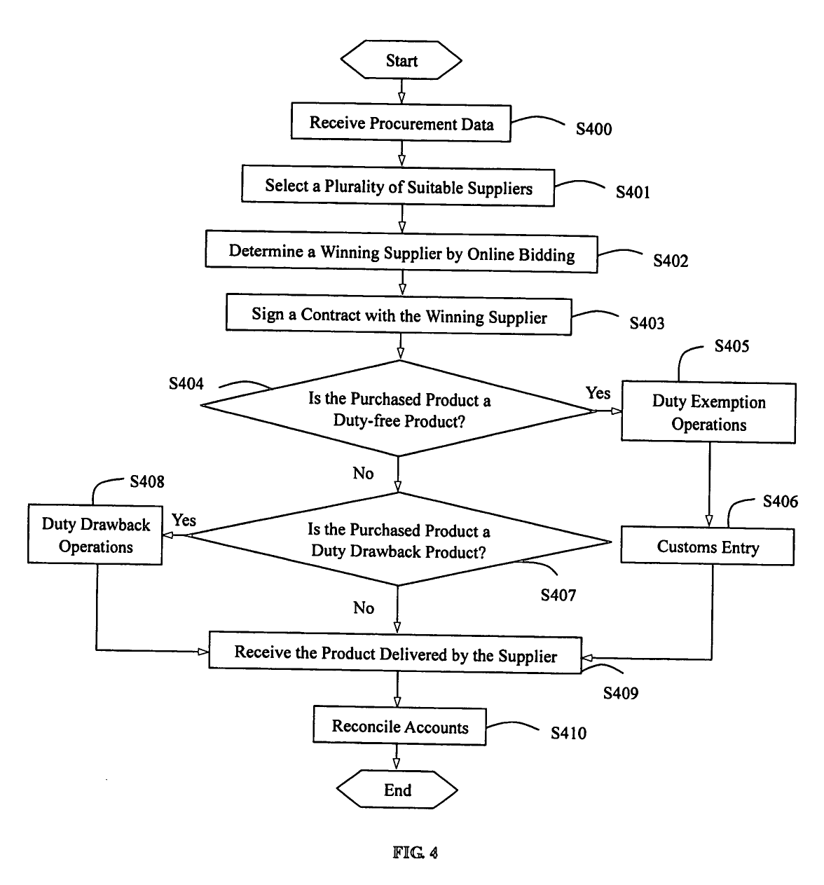

FIG. 4 is a flowchart of a preferred method for performing duty exemption and duty drawback for a product purchased through bidding online. First, procurement data are sent from one client computer 10 to the procurement data maintenance sub-module 1300, and stored in the database 15 at step S400. The supplier data maintenance sub-module 1301 obtains information on corresponding suppliers that provide the product to be purchased as well as information on their products, and selects a plurality of suitable suppliers at step S401 according to the procurement data. The selected suppliers take part in online bidding activities by logging on the website 12. A winning supplier is then generated at step S402 by the online bidding procurement module 131 by comparing bidding results provided by the suppliers. The purchasing organization signs a procurement contract with the winning supplier online at step S403. Afterwards, the duty exemption and duty drawback management module 132 determines whether the purchased product is a duty-free product at step S404 according the procurement data.

If the purchased product is not a duty-free product, the procedure goes directly to step S407 described below. If the purchased product is a duty-free product, a duty-free document and an import declaration are generated by the duty exemption and duty drawback management module 132, and stored in the database 15. The duty-free document and the import declaration are then transferred to the customs computer 19 via the communications network 18. Meanwhile, a message is generated in the application server 13, and transmitted to the supplier computer 17 of the winning supplier at step S405 through the external network 16. The message notifies the winning supplier to deliver the purchased product. When the product arrives at customs, it is checked by customs operators at step S406 according to the duty-free document and the import declaration. Then the procedure goes directly to step S409 described below.

In step S407, the duty exemption and duty drawback management module 132 further determines whether the purchased product is a homemade duty drawback product. If the product is not a homemade duty drawback product, the procedure goes directly to step S409 described below. If the product is a homemade duty drawback product, the duty exemption and duty drawback management module 132 obtains the information on the product, and generates a duty drawback document. The duty drawback document is transmitted to the supplier computer 17 via the external network 16 for the supplier to transact value-added tax invoices and tax payment documents. Afterward, the electronic versions of the value-added tax invoices and tax payment documents are sent to the application server 13 for operators of the purchasing organization to perform duty drawback operations at step S408.

In step S409, the product delivered by the winning supplier is checked by the purchasing organization according to the procurement data. If the quality of the product is not satisfactory, a notice is generated in the application server 13, and sent to the supplier computer 17 to notify the winning supplier either that the product must be re-delivered or that the product will be returned without further dealing. If the product is returned without further dealing, the online bidding procurement module 131 selects a new winning supplier from the other selected suppliers, and the above-described procedure is repeated as necessary until a winning supplier delivers a product of satisfactory quality. If the quality of the product delivered by the winning supplier is satisfactory, in step S410, the purchasing organization accepts the product, and corresponding accounts are reconciled by the accounts balancing module 133.

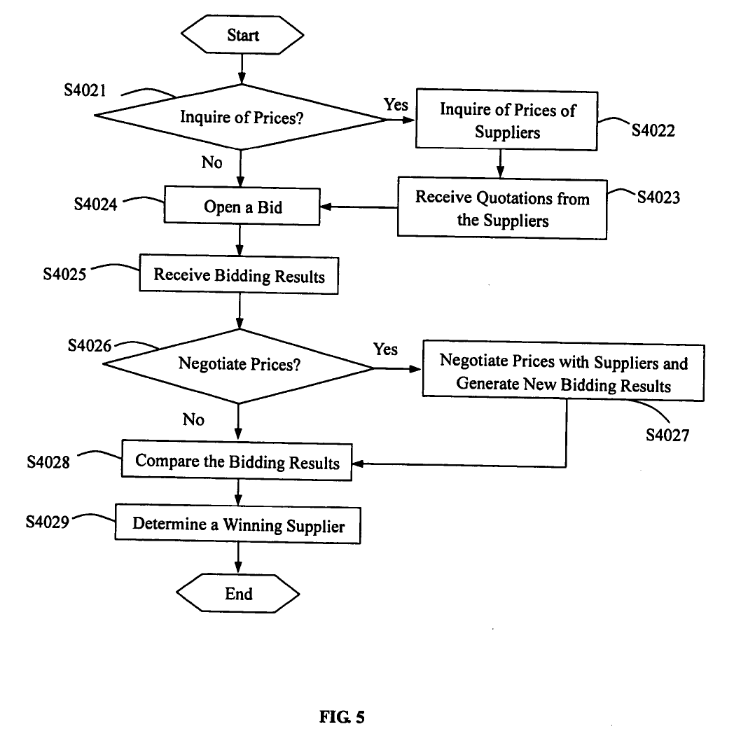

FIG. 5 is a flowchart of a preferred method for implementing step S402 of FIG. 4, namely determining a winning supplier through bidding online. In step S4021, the price enquiry/quoting/price negotiation management sub-module 1310 obtains the information on products of the selected suppliers, and determines whether there is price information in the product information of each selected supplier. If no price information exists in the product information of any selected supplier, the procedure goes to step S4022 in order to inquire of a price of any such selected supplier. If there is price information in the product information of all the selected suppliers, the procedure goes directly to step S4024 described below.

In step S4022, the price enquiry/quoting/price negotiation management sub-module 1310 transfers price inquiring data to the corresponding supplier computers 17 through the external network 16. In step S4023, the inquired suppliers receive the price inquiring data, and provide their respective quotations by logging on the corporation website 12. The price enquiry/quoting/price negotiation management sub-module 1310 accesses the quotations from the corporation website 12, generates quoting records, and stores the quoting records in the database 15.

In step S4024, the online bidding management sub-module 1311 opens a bid, generates a bid opening record, and stores the bid opening record in the database 15. In step S4025, the online bidding management sub-module 1311 receives bidding results from the selected suppliers. In step S4026, the purchasing organization determines whether there is a need to negotiate prices with any supplier according to the bidding results. If there is no need to negotiate prices with any supplier, the procedure goes directly to step S4028 described below.

If there is a need to negotiate prices with any supplier, in step S4027, the price enquiry/quoting/price negotiation management sub-module 1310 receives price negotiating data from relevant client computers 10. The price negotiating data are then transferred to one or more relevant supplier computers 17 through the external network 16. The relevant suppliers reply to the price negotiating data, and offer renewed quotations by logging on the corporation website 12. The price enquiry/quoting/price negotiation management sub-module 1310 accesses the renewed quotations from the corporation website 12, generates new bidding results, and stores the new bidding results in the database 15.

In step S4028, the online bidding management sub-module 1311 directly compares the bidding results. First, the purchasing organization determines a method for comparing the bidding results. The method may be comparing the bidding results only according to prices offered by the selected suppliers, or may involve considering prices and product qualities in combination. Then, by applying the determined method, the online bidding management sub-module 1311 selects a winning supplier according to the quoting records, the price negotiating records and the information on the product to be purchased, generates a bid comparing record, and stores the bid comparing record in the database 15. In step S4029, the online bidding management sub-module 1311 checks the bid comparing record, and grants a winning bid to the winning supplier through the external network 16. The grant of the bid includes notification to the winning supplier to deliver the product. The winning supplier replies to the grant by logging on the corporation website 12. If the winning supplier does not accept the grant, the online bidding management sub-module 1311 compares the bidding results of the other selected suppliers, and selects a new winning supplier. The above-described procedure is repeated as necessary until a winning supplier accepts a grant.

Although the present invention has been specifically described on the basis of a preferred embodiment and preferred methods, the invention is not to be construed as being limited thereto. Various changes or modifications may be made to said embodiment and methods without departing from the scope and spirit of the invention.

What is claimed is:

1. A system for performing duty exemption and duty drawback for products purchased through bidding online, the system comprising a website, an application server, a database, a plurality of client computers and supplier computers, and a customs computer, wherein the application server comprises:
an online bidding procurement module provided for performing price enquiry, quoting and price negotiation, and for managing online bidding activities; and
a duty exemption and duty drawback management module provided for generating duty exemption documents, duty drawback documents and customs declarations, and completing duty exemption and duty drawback for products purchased through bidding online.

2. The system according to claim 1, wherein the application server further comprises a basic data maintenance module provided for maintaining data used or generated in online bidding activities and in processes of duty exemption and duty drawback.

3. The system according to claim 1, wherein the application server further comprises an account reconcilement module provided for balancing relevant accounts after the purchased products are checked and accepted.

4. The system according to claim 1, wherein the online bidding procurement module comprises:
a price enquiry/quoting/price negotiation management sub-module provided for inquiring of prices, receiving quotations from selected suppliers, negotiating prices, and generating price-related records; and
an online bidding management sub-module provided for opening a bid, comparing bidding results according to price-related records, determining a winning supplier and granting a winning bid to the winning supplier, and generating bid-related records.

5. The system according to claim 2, wherein the basic data maintenance module comprises:
a procurement data maintenance sub-module provided for maintaining procurement data including information on products to be purchased;
a supplier data maintenance sub-module provided for maintaining basic information on suppliers and their products, and for selecting a plurality of suitable suppliers according to the procurement data;
a contract maintenance sub-module provided for maintaining procurement contracts signed between a purchasing organization and winning suppliers;
an online procurement record maintenance sub-module provided for maintaining various records used or generated in processes of online bidding procurement; and
a duty exemption and duty drawback data maintenance sub-module provided for maintaining information and documents used or generated in processes of duty exemption and duty drawback.

6. A method for performing duty exemption and duty drawback for a product purchased through bidding online, the method comprising the steps of:
receiving procurement data;
selecting a plurality of suitable suppliers according to the procurement data;
determining a winning supplier by online bidding activities, and entering a procurement contract with the winning supplier;
performing duty exemption operations if the purchased product is a duty-free product; and
checking the product delivered by the winning supplier, and reconciling corresponding accounts.

7. The method according to claim 6, wherein the step of determining a winning supplier by online bidding activities comprises the steps of:
opening a bid;
receiving bidding results provided by selected suppliers;
comparing the bidding results, and determining a winning supplier; and
granting a winning bid to the winning supplier.

8. The method according to claim 6, wherein the step of performing duty exemption operations comprises the steps of:
generating an import duty-free document and an import declaration;
transmitting the import duty-free document and the import declaration to a customs authority, and notifying the winning supplier to deliver the purchased product; and
checking the product delivered by the winning supplier according to the import duty-free document and the import declaration.

9. A method for performing duty exemption and duty drawback for a product purchased through bidding online, the method comprising the steps of:
receiving procurement data;
selecting a plurality of suitable suppliers according to the procurement data;
determining a winning supplier by online bidding activities, and entering a procurement contract with the winning supplier;
performing duty drawback operations if the purchased product is a duty drawback product; and
checking the product delivered by the winning supplier, and reconciling corresponding accounts.

10. The method according to claim 9, wherein the step of performing duty drawback operations comprises the steps of:
generating a duty drawback document, and transmitting the duty drawback document to the winning supplier; and
transacting value-added invoices and tax payment documents, and transferring the value-added invoices and the tax payment documents to an application server.
